(19) United States
(12) Patent Application Publication
(10) Pub. No.: US 2016/0378632 A1
(43) Pub. Date: Dec. 29, 2016

(54) PORT SELECTION AT A COMPUTING DEVICE

(71) Applicant: Intel Corporation, Santa Clara, CA (US)

(72) Inventor: Amit Kumar Srivastava, Penang (MY)

(73) Assignee: Intel Corporation, Santa Clara, CA (US)

(21) Appl. No.: 14/752,042

(22) Filed: Jun. 26, 2015

(51) Int. Cl. G06F 11/30; G06F 9/44; G06F 11/14; G06F 13/42

(52) U.S. Cl. CPC G06F 11/3051; G06F 13/4286; G06F 9/4411; G06F 11/1417; G06F 11/1423; G06F 11/3041

(57) ABSTRACT

Techniques for port selection are described herein. The techniques may include an apparatus a transceiver including a plurality of ports. The apparatus includes a selector to select a port from among the plurality of ports. The port is selected to receive a repair operation to repair a basic input output system.

### TECHNICAL FIELD

This disclosure relates generally to techniques for port selection over a computer bus. Specifically, this disclosure relates to selecting a port for receiving operations to repair a computing device.

### BACKGROUND ART

A computing device may include a basic input output system (BIOS) that is initiated during a booting process when the computing device is turned on. In some cases, a BIOS may become corrupted rendering the computing device at least partially inoperable. A Download and Execute (DnX) operation may be used to download and repair a BIOS or binary over a computer bus, such as Universal Serial Bus (USB). For example, a computer tablet may be connected to a host device, such as a laptop computer when a BIOS of the computer tablet has become corrupted. A DnX may contain repairs or a new BIOS that may be executed after proper verification. During DnX a physical layer (PHY) of a receiver of the port may be configured in device mode if a dual role mode of the receiver is available.

### BRIEF DESCRIPTION OF THE DRAWINGS

FIG. 1 is a block diagram illustrating a host computing device and a peripheral computing device having multiple ports.

FIG. 2 is a block diagram illustrating a computing device configured to select one port from a plurality of ports.

FIG. 3 is a flow diagram illustrating port selection in for downloading repair operations.

FIG. 4 is a flow diagram port selection for downloading repair operations based on voltage detection.

FIG. 5 is a flow diagram port selection in an all-in-one port for downloading repair operations based on voltage detection.

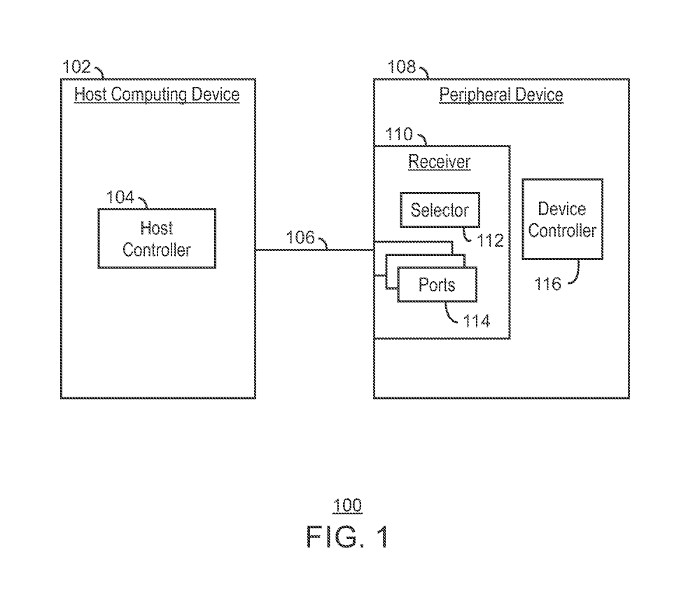

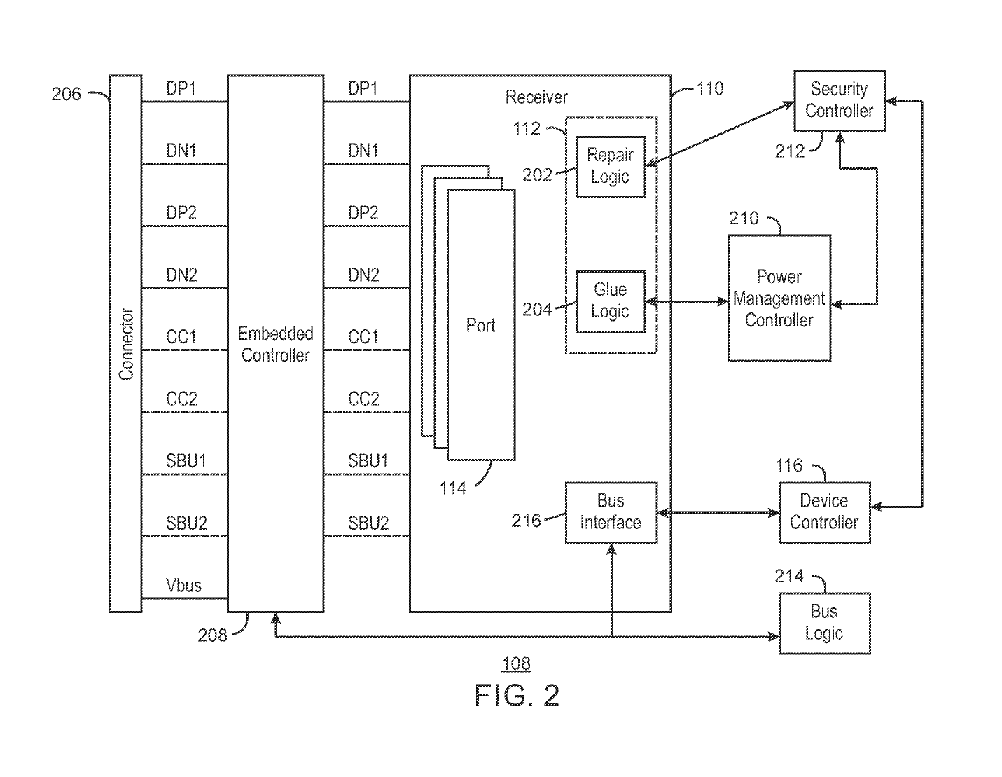

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The present disclosure relates generally to techniques for port selection in a repair operation over a computer bus. As discussed above, a repair operation may include a download and execute (DnX) operation used to download a BIOS or binary over a computer bus, such as Universal Serial Bus (USB), when a BIOS of a computing device is corrupted.

In some cases, a given computing device having a corrupted BIOS may include more than one port. For example, a tablet may include multiple ports wherein only one of the multiple ports is configured to receive a repair operation, such as a DnX operation. In this scenario, only one port may be connected to a device controller that is able to process the repair operation. Therefore, if a computing device includes multiple ports, a user may need to check each port to determine whether a repair operation is supported at each port or have a prior knowledge of ports which support repair operation.

In the techniques described herein, an apparatus, such as a computing device, may include a receiver having multiple ports. Logic may include a selector to select one of the ports for receiving repair operations to repair a BIOS. Selection of the port may be based on detecting a voltage signal on a voltage line of a computer bus. An example of a computer bus may include a Universal Serial Bus (USB) indicated in a specification standard entitled, “The USB 3.1 Specification released on Jul. 26, 2013 and ECNs approved through Aug. 11, 2014,” referred to herein as the “USB specification.”

In some cases, a port may include an all-in-one port. An all-in-one port may provide a power interface, may be at least partially or fully reversible, and may include general data interfaces as well as additional data-specific interfaces such as a display interface, an audio interface, and the like. An example of an all-in-one port may include a Universal Serial Bus (USB) “Type C” connector, indicated in a specification standard entitled, “USB Type-C Cable and Connector Specification Revision 1.0, Aug. 11, 2014,” referred to herein as the “USB Type-C specification.” As discussed in more detail below, the USB Type-C connector may include a reversible plug connector. Other all-in-one ports may be implemented in the debug techniques described herein. However, for simplicity, the all-in-one port may be interchangeably referred to herein as or as simply an all-in-one port in general or as an USB Type-C connector.

The reversibility of an all-in-one connector, such as the USB Type-C connector, may characterize two different ports: one port in a first orientation and a second port in a reversed orientation. In this scenario, the techniques described herein may select a port based on orientation by detecting a signal at an orientation pin, as well as detecting a voltage signal at a voltage bus associated with the port. In some cases, a computing device may include multiple all-in-one ports each with multiple orientation-based ports. In this case, the techniques described herein may select a port by detecting a signal at an orientation pin from among multiple orientation pins, as well as a voltage signal detected at the port.

As discussed in more detail below, once a port is selected based at least on voltage detection, the techniques described herein enable repair operations such as DnX, to be executed at the computing device. In some cases, the execution of the repair operations may repair a corrupted BIOS. Further, the execution of the repair operations may be done during an isolation mode. By enabling repair operations in isolation mode, a self-enabled boot may be initiated without necessarily providing a handshake with a host device. More specifically, the techniques described herein include executing the repair operations by providing an independent clock, such as a ring oscillator. Isolation mode, as referred to herein, includes executing the repair operations while restricting at least some other operations of the computing device until the repair operation is complete. For example, during execution of the repair operation, components of a system-on-chip (SOC), such as a device controller or host controller. Further, in some cases, a device in isolation mode may not require a reset. In other words, only components of a physical layer of the computing device necessary for execution of the repair operations may be enabled.

FIG. 1 is a block diagram illustrating a host computing device and a peripheral computing device having multiple ports. The computing system 100 may include a computing device 102 having a host controller 104. The host computing device 102 may be connected via a computer bus 106 to a peripheral device 108.

The peripheral device may include a receiver 110 having a selector 112 and multiple ports 114. As illustrated in FIG. 1, the peripheral device 108 may include a device controller 116. In some cases, the reciever 110 is implemented as a transceiver configured to transmit as well as receive signals including signals related to port selection in a repair operation over the computer bus 106.

The selector 112 may include logic, at least partially including hardware logic, such as electronic circuitry. In some cases, the selector 112 may be any combination of electronic circuitry logic, firmware of a microcontroller, and the like. As discussed above and in more detail below, the selector 112 may detect which of the ports 114 have a signal on a voltage bus indicating that the detected port is to enable repair operations over the port. Once a voltage signal is detected on a given one of the ports 114, the port is placed in isolation mode, and the repair operations are initialized and completed.

In some cases, one or more of the ports 114 may include an all-in-one port, such as a USB Type-C port. In this case, if an all-in-one port is used to connect to the host computing device 102 to the peripheral device 108, an orientation pin may be detected indicating which orientation, and therefore, which orientation-based port of the all-in-one port is being used, as discussed in more detail below. Once the orientation-based port is determined, the port will be selected if a voltage signal on a voltage bus is detected.

In some cases, controllers, such as the host controller 104 and the device controller 116 may be dual role controllers. In this scenario, either controller is first configured as either a host or device. In the case of repair operations, the host controller 104 is configured in host mode and the device controller 116 is configured in device mode. In some cases, when a BIOS of the peripheral device 108 is corrupted, the device controller 116 may default to device mode.

FIG. 2 is a block diagram illustrating a computing device configured to select one port from a plurality of ports. In FIG. 2, a computing device, such as the peripheral computing device 108 of FIG. 1, may include a selector, such as the selector 112 of FIG. 1, as indicated by the dashed box 112. In FIG. 2, the selector 112 may include repair logic 202 and glue logic 204. Ports, such as the multiple ports 114 of FIG. 1, may be connected to a connector 206 via an embedded controller 208 and bus lines including a first positive data line (DP1), a first negative data line (DN1), a second positive data line (DP2), a second negative data line (DP2).

In FIG. 2, DP1 and DN1 form a first differential pair while DP2 and DN2 form a second differential pair. In the case where the connector 206 is a USB Type-C connector, additional bus lines may include a first configuration channel line (CC1), a second configuration channel line (CC2), a first side band use channel (SBU1), and a second side band use channel (SBU2). In either case, the embedded controller 208 also connects to a voltage bus (Vbus).

During initialization of the device 108 early bring-up stages may be implemented. As discussed in more detail below, a power management controller 210 enables a system-on-chip (SOC) (not shown) based on the presence of charging activity indicated at the Vbus or manual power on. Presence of voltage on the Vbus may indicate that a repair operation is available and pending. In some cases, a repair operation may be detected if a power button is held for a predefined period of time. In any case, a security controller 212 may determine whether the repair operation is valid based on a key pair associated with the pending repair operation. If the pending repair operation is valid, the security controller 212 will signal the embedded controller to register status changes. The embedded controller 208 may include status registers for each of the ports 114. The repair logic 202 may be configured to detect which status register changes occur for a respective port. A port from among the ports 114 having a detected status register change may be then configured in device mode and in isolation mode while the repair operation is executed and until the repair operation is completed. Upon completion of the repair operation, the security controller 212 may configure a physical layer associated with the detected port in host mode, and the SOC may be directed to complete the booting process.

As discussed above, the connector 206 may be an all-in-one connector that is at least partially reversible. In other words, the connector 206 may receive a reversible plug wherein orientation may be detected. Each orientation may be considered a separate port among the ports 114. In this scenario, before detecting whether a voltage signal is present on the Vbus, the embedded controller 208 may detect which of the CC1 or CC2 pins for a given port 114 has a voltage signal. In some cases, these CC1 and CC2 pins may be described as orientation pins. In some cases, the orientation detection may be provided from the embedded controller 208 to bus logic 214. The bus logic 214 may be configured to broadcast the orientation detection back to the receiver 110 via a bus interface 216. Once detecting the orientation, and therefore the port having a voltage signal at either the CC1 pin or the CC2 pin, the process may proceed as described above wherein presence of voltage on the Vbus may indicate that a repair operation is available and pending.

In either case, the port having voltage on the Vbus may be selected as a port for carrying out a repair operation such as a download and execute operation for repairing a system, such as a BIOS (not shown) of the device 108. As discussed above, selection of one port from among the ports 114, as well as execution of the repair operation may be performed with the selected port in isolation mode with an independent clock, such as the ring oscillator. The independent clock may enable repair operations to be completed without enabling the device controller 116. In some cases, signaling between the glue logic 204 and the power management controller 210 may be provided to suspend operations of other components such as the device controller 116 during repair operations. In other words, even when the computing device 108 includes faulty or corrupted booting components such as a corrupted BIOS, the receiver 110 may select the correct port being used to communicate the repair operation.

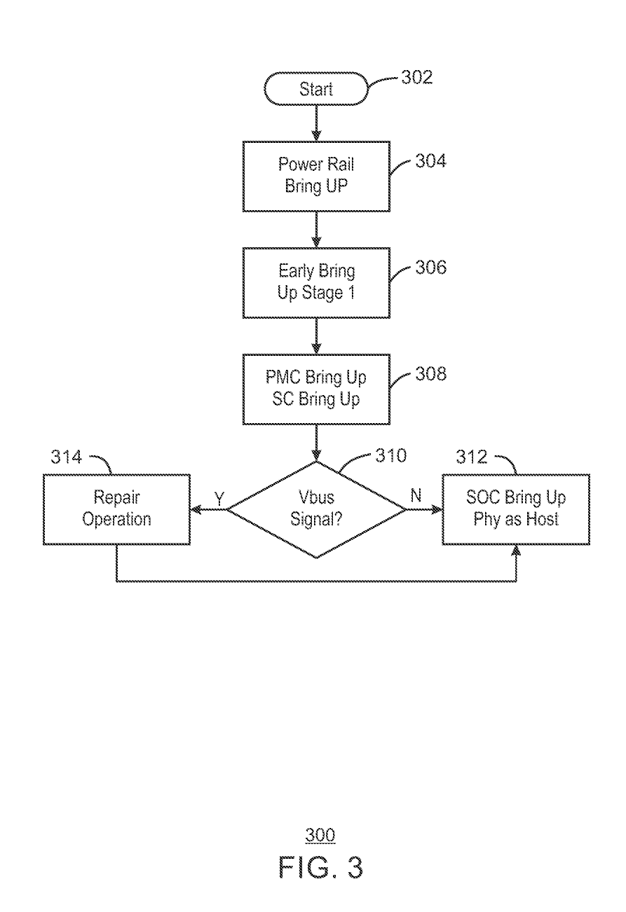

FIG. 3 is a flow diagram illustrating port selection in for downloading repair operations. As discussed above, a power management controller 210 enables a system-on-chip (SOC) based on the presence of charging activity indicated at the Vbus or manual power on at 302. At 304, power rails associated with a CRO are enabled and a ring oscillator clock is enabled. At block 306, an early stage bring-up is initiated wherein an embedded debug boot sequence at the embedded controller 208. During block 304, the device controller 116 may be inaccessible during the isolation state. At block 308, the power management controller 210 and the security controller 212 are initiated. Presence of voltage on the Vbus of FIG. 2 may indicate that a repair operation is available and pending. Accordingly, the Vbus is checked to determine whether a voltage signal is present at 310. If there is not a Vbus signal at 310, the process 300 continues to bring up the SOC and configure the physical layer as a host at block 312. However, if a Vbus signal is detected at 310, then a repair operation is initiated and completed at 314, and thereafter the SOC may be brought up as indicated in FIG. 3.

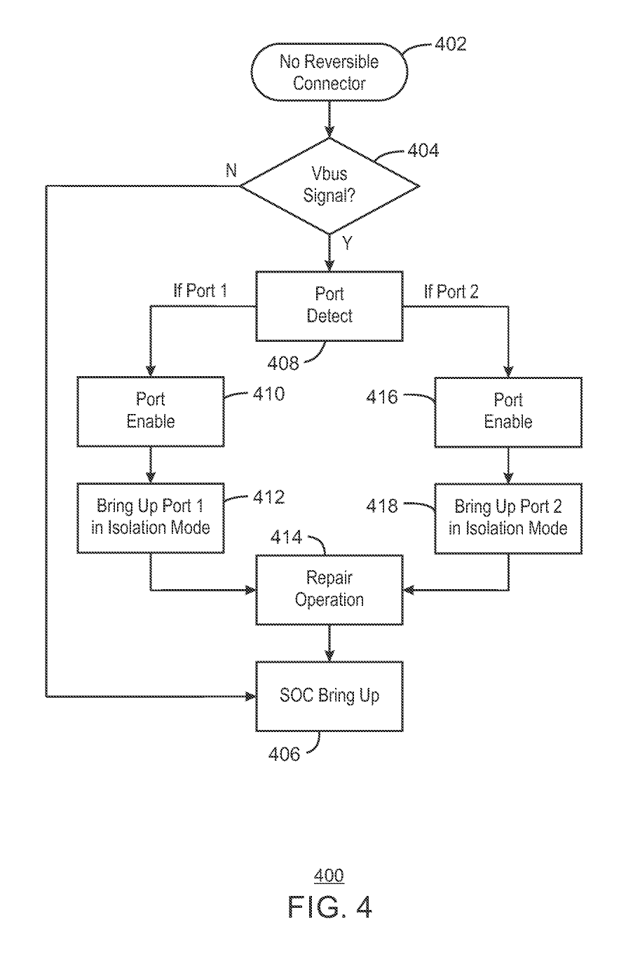

FIG. 4 is a flow diagram port selection for downloading repair operations based on a voltage detection. As discussed above, the techniques described herein include selecting a port for communicating repair operations based on detection of voltage at a Vbus, such as the Vbus of FIG. 2. In FIG. 4, a process 400 is illustrated when the connector is not a reversible connector. At block 402, the connector is determined not to be a reversible connector. The determination at block 402 may be based on the absence of a CC1 or CC2 signal. Similar to block 310 of FIG. 3, at block 404, it is determined whether a signal is present on the Vbus. If no Vbus signal is detected, then, similar to block 312 of FIG. 3, the process 400 continues to bring up an SOC of the subject computing device, such as the computing device 108 of FIG. 1 and FIG. 2, as indicated at block 406.

If a Vbus signal is detected at 404, then at 408 the port for which the Vbus is detected is determined. If a first port is detected as having the Vbus signal, then, at block 410, the first port is enabled at 410. In some cases, the physical layer of the computing device 102 is configured in a device mode such that repair operations may be received. At 412, the first port is brought up in isolation mode, and repair operations are executed at 414, similar to block 314 of FIG. 3. However, if a Vbus signal is not detected for the first port, but is detected for a second port, then, at block 416, the second port is enabled. At block 418, the second port is brought up in isolation mode, and the repair operation is executed at 414. Once repair operations are executed and completed on either the first or second port, the SOC is brought up at 406.

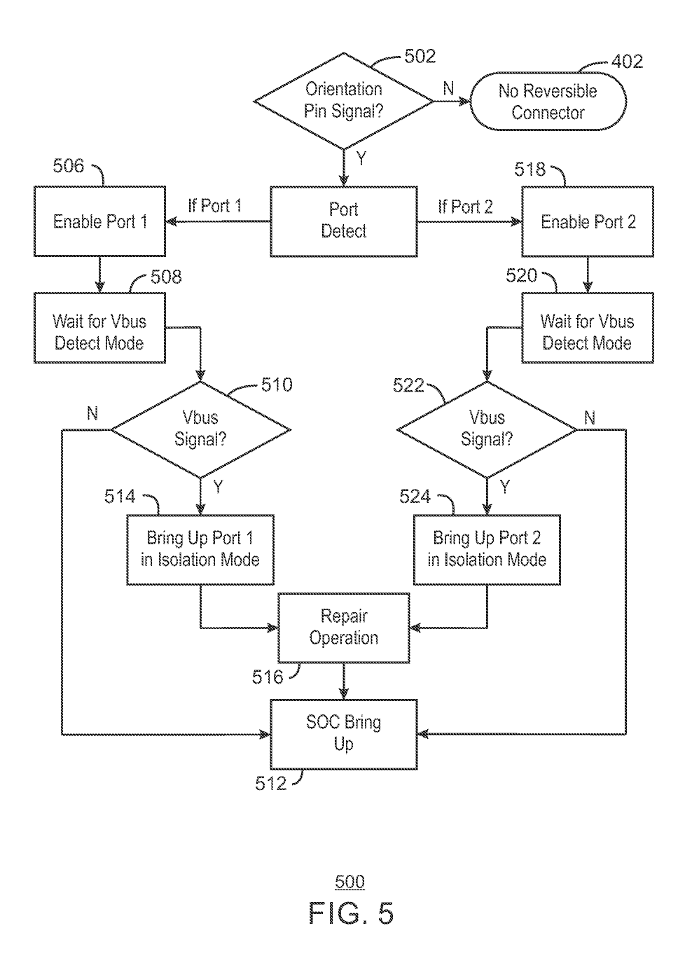

FIG. 5 is a flow diagram port selection in an all-in-one port for downloading repair operations based on a voltage detection. As discussed above, in some cases a connector may be configured to be reversible in that a plug may be received in more than one orientation. In this scenario, orientation may represent a port to be detected. Accordingly, at 402, detection of CC1 and/or CC2 pins is performed. If no CC1 or CC2 pins are detected, then the process 500 reverts to block 402 of FIG. 4. If orientation signals are present on either the CC1 pin or the CC2 pin, then the port associated with the signal is detected at 504. In this scenario, port 1 is thought of as a first orientation, while port 2 is thought of as a second orientation associated with the all-in-one port. In other words, each all-in-one port may include multiple ports, each associated with a different supported orientation.

For example, if a signal is detected at CC1 of FIG. 2, a first port is enabled at 506, and at 508 a Vbus detect mode is waited for. Once the Vbus detect mode is enabled, a determination is made as to whether there is a Vbus signal for the first port, as indicated at block 510. If no Vbus signal is detected at 510, then the SOC is brought up at 512, similar to block 408 of FIG. 4, and block 312 of FIG. 3.

However, if a Vbus signal is detected at block 510, then port 1 is brought up in isolation mode at block 514. Then, at block 516, a repair operation is executed and completed. Once the repair operation is completed at 516, the SOC is brought up as indicated at 512. If, on the other hand, a signal is detected at CC2, for example, a second port is enabled at 518, and Vbus detect mode is waited upon at block 520. Once Vbus detect mode has been enabled, a determination is made as to whether a Vbus signal is present on the Vbus, as indicated at 522. If a Vbus signal is not detected, then the SOC is brought up at 512. If, however, a Vbus signal is detected at 522, then the second port is brought up in isolation mode at 524, and repair operations are executed and completed at 516. Once the repair operations are executed and completed at 516, then SOC is then brought up at 512.

In some cases, a computing device, such as the computing device 108 of FIG. 1 and FIG. 2, may include multiple all-in-one ports each having two orientation-based ports. In this scenario, detection of whether a signal exists on an orientation pin at 502 may include determining upon which configuration channel of which all-in-one port the signal is occurring. In this case, the computing device 108 may include CC1_1 and CC2_1 channels indicating configuration channels for a first all-in-one port, while CC1_2 and CC2_2 may indicate configuration channels of a second all-in-one port. Therefore, the port detection at 504 may be enabled to determine which orientation port has an orientation signal.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Example 1 is an apparatus for port selection. In this example, the wireless charging device may include a transceiver comprising a plurality of ports, a selector to select a port from among the plurality of ports for receiving an operation to repair a basic input output system.

Example 2 includes the apparatus of example 1. In this example, the transceiver is configured in isolation mode during the repair operation.

Example 3 includes the apparatus of any combination of examples 1-2. In this example isolation mode may include restricting operations of a system-on-chip until the repair operation is complete.

Example 4 includes the apparatus of any combination of examples 1-3. In this example isolation mode may include receiving the repair operation without handshake operations over the selected port.

Example 5 includes the apparatus of any combination of examples 1-4. In this example selection of the selected port is based on a detection of a signal at a voltage bus of the selected port indicating the repair operation is provided at the port.

Example 6 includes the apparatus of any combination of examples 1-5. In this example, the selected port is a first port in an all-in-one port comprising a second port associated with an orientation that is different than an orientation of the first port.

Example 7 includes the apparatus of any combination of examples 1-6. In this example selection of the selected port is further based on a detection of a signal at an orientation pin associated with the first port.

Example 8 includes the apparatus of any combination of examples 1-7. In this example, the all-in-one port is one among a plurality of all-in-one ports, and wherein the selected port is selected from among a plurality of first and second ports respectively associated with each of the plurality of all-in-one ports.

Example 9 includes the apparatus of any combination of examples 1-8. In this example, the receiver is configured to receive a clock signal associated with the repair operation that is independent of other operations on the port.

Example 10 includes the apparatus of any combination of examples 1-9. In this example, the selector may include logic, at least partially comprising hardware logic, of a physical layer of the apparatus.

Example 11 is a method for port selection. In this example, the wireless charging device may include selecting a port from among a plurality of ports of a transceiver to receive an operation configured to repair a basic input output system, receiving the download and execution operation at the selected port.

Example 12 includes the method of example 11. This example includes entering the transceiver to isolation mode during the repair operation.

Example 13 includes the method of any combination of examples 11-12. In this example isolation mode may include restricting operations of a system-on-chip until the repair operation is complete.

Example 14 includes the method of any combination of examples 11-13. In this example isolation mode may include receiving the repair operation without handshake operations over the selected port.

Example 15 includes the method of any combination of examples 11-14. In this example selection of the selected port is based on a detection of a signal at a voltage bus of the selected port indicating the repair operation is provided at the port.

Example 16 includes the method of any combination of examples 11-15. In this example, the selected port is a first port in an all-in-one port comprising a second port associated with an orientation that is different than an orientation of the first port.

Example 17 includes the method of any combination of examples 11-16. In this example selection of the selected port is further based on a detection of a signal at an orientation pin associated with the first port.

Example 18 includes the method of any combination of examples 11-17. In this example, the all-in-one port is one among a plurality of all-in-one ports, and wherein the selected port is selected from among a plurality of first and second ports respectively associated with each of the plurality of all-in-one ports.

Example 19 includes the method of any combination of examples 11-18. In this example receiving the download and execute operation may include receiving a clock signal associated with the repair operation that is independent of other operations on the port.

Example 20 includes the method of any combination of examples 11-19. In this example selecting the port is performed at a physical layer associated with the selected port.

Example 21 is a system for port selection. In this example, the wireless charging device may include a basic input output system, a transceiver comprising a plurality of ports, a selector to select a port from among the plurality of ports for receiving an operation to repair the basic input output system.

Example 22 includes the system of example 21. In this example, the transceiver is configured in isolation mode during the repair operation.

Example 23 includes the system of any combination of examples 21-22. In this example isolation mode may include restricting operations of a system-on-chip until the repair operation is complete.

Example 24 includes the system of any combination of examples 21-23. In this example isolation mode may include receiving the repair operation without handshake operations over the selected port.

Example 25 includes the system of any combination of examples 21-24. In this example selection of the selected port is based on a detection of a signal at a voltage bus of the selected port indicating the repair operation is provided at the port.

Example 26 includes the system of any combination of examples 21-25. In this example, the selected port is a first port in an all-in-one port comprising a second port associated with an orientation that is different than an orientation of the first port.

Example 27 includes the system of any combination of examples 21-26. In this example selection of the selected port is further based on a detection of a signal at an orientation pin associated with the first port.

Example 28 includes the system of any combination of examples 21-27. In this example, the all-in-one port is one among a plurality of all-in-one ports, and wherein the selected port is selected from among a plurality of first and second ports respectively associated with each of the plurality of all-in-one ports.

Example 29 includes the system of any combination of examples 21-28. In this example, the receiver is configured to receive a clock signal associated with the repair operation that is independent of other operations on the port.

Example 30 includes the system of any combination of examples 21-29. In this example, the selector may include logic, at least partially comprising hardware logic, of a physical layer of the apparatus.

Example 31 is an apparatus for port selection. In this example, the wireless charging device may include a transceiver comprising a plurality of ports, a means to select a port from among the plurality of ports for receiving an operation to repair a basic input output system.

Example 32 includes the apparatus of example 31. In this example, the transceiver is configured in isolation mode during the repair operation.

Example 33 includes the apparatus of any combination of examples 31-32. In this example isolation mode may include restricting operations of a system-on-chip until the repair operation is complete.

Example 34 includes the apparatus of any combination of examples 31-33. In this example isolation mode may include receiving the repair operation without handshake operations over the selected port.

Example 35 includes the apparatus of any combination of examples 31-34. In this example selection of the selected port is based on a detection of a signal at a voltage bus of the selected port indicating the repair operation is provided at the port.

Example 36 includes the apparatus of any combination of examples 31-35. In this example, the selected port is a first port in an all-in-one port comprising a second port associated with an orientation that is different than an orientation of the first port.

Example 37 includes the apparatus of any combination of examples 31-36. In this example selection of the selected port is further based on a detection of a signal at an orientation pin associated with the first port.

Example 38 includes the apparatus of any combination of examples 31-37. In this example, the all-in-one port is one among a plurality of all-in-one ports, and wherein the selected port is selected from among a plurality of first and second ports respectively associated with each of the plurality of all-in-one ports.

Example 39 includes the apparatus of any combination of examples 31-38. In this example, the receiver is configured to receive a clock signal associated with the repair operation that is independent of other operations on the port.

Example 40 includes the apparatus of any combination of examples 31-39. In this example, the means to select the port from among the plurality of ports may include logic, at least partially comprising hardware logic, of a physical layer of the apparatus.

Example 41 is a system for port selection. In this example, the wireless charging device may include a basic input output system, a transceiver comprising a plurality of ports, a means for selecting a port from among the plurality of ports for receiving an operation to repair the basic input output system.

Example 42 includes the system of example 41. In this example, the transceiver is configured in isolation mode during the repair operation.

Example 43 includes the system of any combination of examples 41-42. In this example isolation mode may include restricting operations of a system-on-chip until the repair operation is complete.

Example 44 includes the system of any combination of examples 41-43. In this example isolation mode may include receiving the repair operation without handshake operations over the selected port.

Example 45 includes the system of any combination of examples 41-44. In this example selection of the selected port is based on a detection of a signal at a voltage bus of the selected port indicating the repair operation is provided at the port.

Example 46 includes the system of any combination of examples 41-45. In this example, the selected port is a first port in an all-in-one port comprising a second port associated with an orientation that is different than an orientation of the first port.

Example 47 includes the system of any combination of examples 41-46. In this example selection of the selected port is further based on a detection of a signal at an orientation pin associated with the first port.

Example 48 includes the system of any combination of examples 41-47. In this example, the all-in-one port is one among a plurality of all-in-one ports, and wherein the selected port is selected from among a plurality of first and second ports respectively associated with each of the plurality of all-in-one ports.

Example 49 includes the system of any combination of examples 41-48. In this example, the receiver is configured to receive a clock signal associated with the repair operation that is independent of other operations on the port.

Example 50 includes the system of any combination of examples 41-49. In this example, the means for selecting the port from among the plurality of ports may include logic, at least partially comprising hardware logic, of a physical layer of the apparatus.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus for port selection, comprising:
a transceiver comprising a plurality of ports;
a selector to select a port from among the plurality of ports for receiving an operation to repair a basic input output system.

2. The apparatus of claim 1, wherein the transceiver is configured in isolation mode during the repair operation.

3. The apparatus of claim 2, wherein isolation mode comprises restricting operations of a system-on-chip until the repair operation is complete.

4. The apparatus of claim 2, wherein isolation mode comprises receiving the repair operation without handshake operations over the selected port.

5. The apparatus of claim 1, wherein selection of the selected port is based on a detection of a signal at a voltage bus of the selected port indicating the repair operation is provided at the port.

6. The apparatus of claim 5, wherein the selected port is a first port in an all-in-one port comprising a second port associated with an orientation that is different than an orientation of the first port.

7. The apparatus of claim 6, wherein selection of the selected port is further based on a detection of a signal at an orientation pin associated with the first port.

8. The apparatus of claim 6, wherein the all-in-one port is one among a plurality of all-in-one ports, and wherein the selected port is selected from among a plurality of first and second ports respectively associated with each of the plurality of all-in-one ports.

9. The apparatus of claim 1, wherein the receiver is configured to receive a clock signal associated with the repair operation that is independent of other operations on the port.

10. The apparatus of claim 1, wherein the selector comprises logic, at least partially comprising hardware logic, of a physical layer of the apparatus.

11. A method for port selection, comprising:
selecting a port from among a plurality of ports of a transceiver to receive an operation configured to repair a basic input output system;
receiving the download and execution operation at the selected port.

12. The method of claim 11, further comprising entering the transceiver to isolation mode during the repair operation.

13. The method of claim 12, wherein isolation mode comprises restricting operations of a system-on-chip until the repair operation is complete.

14. The method of claim 12, wherein isolation mode comprises receiving the repair operation without handshake operations over the selected port.

15. The method of claim 11, wherein selection of the selected port is based on a detection of a signal at a voltage bus of the selected port indicating the repair operation is provided at the port.

16. The method of claim 15, wherein the selected port is a first port in an all-in-one port comprising a second port associated with an orientation that is different than an orientation of the first port.

17. The method of claim 16, wherein selection of the selected port is further based on a detection of a signal at an orientation pin associated with the first port.

18. The method of claim 16, wherein the all-in-one port is one among a plurality of all-in-one ports, and wherein the selected port is selected from among a plurality of first and second ports respectively associated with each of the plurality of all-in-one ports.

19. The method of claim 11, wherein receiving the download and execute operation comprises receiving a clock signal associated with the repair operation that is independent of other operations on the port.

20. The method of claim 11, wherein selecting the port is performed at a physical layer associated with the selected port.

21. A system for port selection, comprising:
a basic input output system;
a transceiver comprising a plurality of ports;
a selector to select a port from among the plurality of ports for receiving an operation to repair the basic input output system.

22. The system of claim 21, wherein the transceiver is configured in isolation mode during the repair operation, wherein isolation mode comprises restricting operations of a system-on-chip until the repair operation are complete, and wherein isolation mode comprises receiving the repair operation without handshake operations over the selected port.

23. The system of claim 21, wherein selection of the selected port is based on a detection of a signal at a voltage bus of the selected port indicating the repair operation is provided at the port.

24. The apparatus of claim 23, wherein the selected port is a first port in an all-in-one port comprising a second port associated with an orientation that is different than an orientation of the first port.

25. The apparatus of claim 24, wherein selection of the selected port is further based on a detection of a signal at an orientation pin associated with the first port.
